(19) United States
(12) Patent Application Publication
(10) Pub. No.: US 2014/0120818 A1
(43) Pub. Date: May 1, 2014

(54) Attic Ventilation Turbine with Integrated Flex Blade

(71) Applicant: Chris Bennett, Azle, TX (US)

(72) Inventor: Chris Bennett, Azle, TX (US)

(21) Appl. No.: 13/661,055

(22) Filed: Oct. 26, 2012

(51) Int. Cl. F24F 7/02; F03D 3/00

(52) U.S. Cl. CPC F24F 7/025; F03D 3/005
USPC 454/16; 454/18

(57) ABSTRACT

The invention is an Attic Ventilation Turbine with Integrated Flex Blade that has a Scoop-Blade Turbine Shroud with an integrated Fan constructed within the Shroud so that ambient wind rotates the Shroud. When the Shroud rotates, the Fan is rotated along with the Shroud so that warm air within the attic is pulled out of the attic through the Turbine. The Fan is constructed with a number of flexible metal Blades that flatten as the Shroud spins faster.

### CROSS-REFERENCES TO RELATED APPLICATIONS

None.

### STATEMENT REGARDING FEDERALLY SPONSORED RESEARCH AND DEVELOPMENT

None.

The Names of the Parties To A Joint Research Agreement

None.

### INCORPORATION-BY-REFERENCE OF MATERIAL SUBMITTED ON A COMPACT DISC

None.

### BACKGROUND OF THE INVENTION

1. Field of the Invention

Attic ventilation fan systems.

2. Background Art

Attics accumulate warm air during the heat of the day, resulting in roof chamber temperatures exceeding 120° F. The construction industry has developed many attic ventilation systems to remove this heat.

There are many attic fan systems made with many different forms of construction, but the general approach uses a shroud placed over a sleeved opening in the roof, constructed to catch with ambient wind and turn the shroud to keep rain out of the shaft, and under some circumstances, pulling hot air from within the attic into the air above the roof. U.S. Pat. No. 6,302,778 ('778) provides a typical rendition, which potentially involves a sleeve installed in a building's roof such that hot air enters a lower end opening inside the attic space, and the upper end of the sleeve releasing the hot air outside the building. Wind turns a rotating shroud that sits on the top of the sleeve, the shroud constructed to pull the attic's air through the sleeve and to keep rain from entering the sleeve. In the disclosure of '778, a fan is installed inside the sleeve area, mounted on a shaft that turns with the shroud, and pulls the hot air through the sleeve. An additional option in the '778 device is an electric motor sitting below the sleeve-installed fan, to pull the air through even when no wind is blowing to power the shroud's rotation.

This '778 construction is highly efficient and functions well, but its design and construction of '778 has as a disadvantage, in that it requires a vertical sleeve so the sleeve-installed fan can be installed below the shroud.

Another common problem with existing attic fans is the noise level that results from the units when they spin.

The industry needs less noisy compact roof-mounted attic fans.

### BRIEF SUMMARY OF THE INVENTION

The invention shown in FIG. 1 is a roof-mounted Attic Ventilation Turbine with an integrated fan installed within the Turbine. The integrated fan is affixed to the axis of the Turbine so that ambient wind turning the Turbine also turns the integrated fan which pulls warm air out of attics

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### BRIEF DESCRIPTION OF THE SEVERAL VIEWS OF THE DRAWING(S)

FIG. 1 is a cross sectional side view of an embodiment of the invention.

FIG. 2 is a bottom view of an embodiment of the invention.

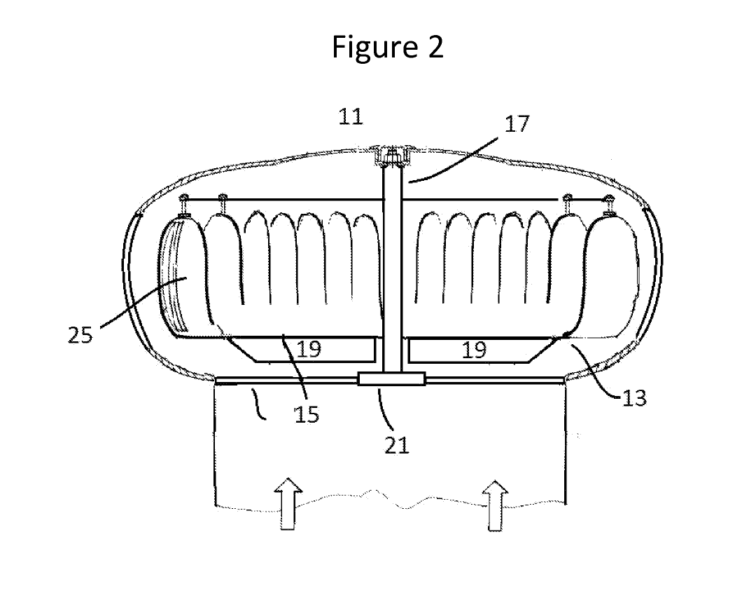

### DETAILED DESCRIPTION OF THE INVENTION

The invention described herein builds upon existing designs of roof-mounted attic ventilation fans. The invention improves upon the prior art by placing a horizontal fan in the volume of the turbine, and constructing the blades of the fan so they flatten as the speed of the turbine's rotation increases to diminish the sound generated by the turbine.

As shown in Drawing 1, the Attic Ventilation Turbine 11 comprises a Scoop-Type Turbine Shroud 13 with an integrated Fan 15 installed within the Shroud 13, and built as part of the Shroud 13 such that the Fan 15 rotates with the Shroud 13. Both the Shroud 13 and Fan 15 are mounted on a Shaft 17. The Shaft 17 extends the height of the invention. A Support Structure 21 holds the Shaft 17 at the top and bottom of the Turbine 11. In the current embodiment, ball bearings are used to allow the Shaft 17 to easily turn, but other means can also be employed, such as sleeve or magnetic bearings.

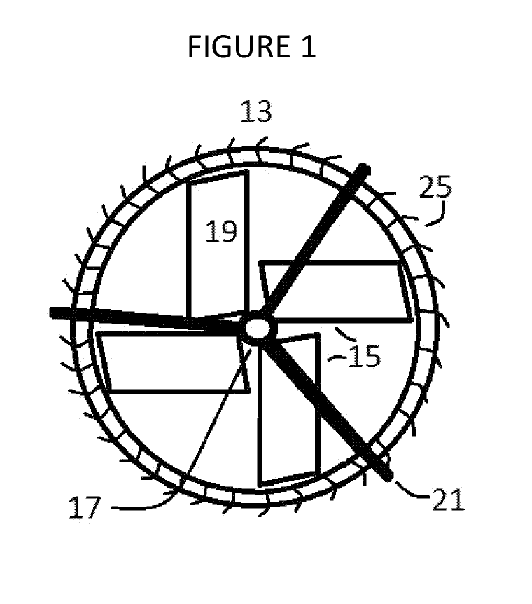

As seen in FIG. 1, the Turbine 11 includes a Support Structure 21 that allows for mounting of the Shaft 17 and Shroud 13 onto a roof. All ventilation turbines in the industry have some sort of support structure that serves this purpose; anyone familiar with the art can design and build this structure, which has a top portion to hold the Shaft 17 at its top, and to avoid rain falling through the structure into the roof.

Similarly, the Turbine 11 includes a round Shroud 13 which rotates when ambient wind pushes on multiple vertical curved “scoop” blades or vanes (turbines typically include 12-24 blades), as shown in the figures. This is a common shroud construction known in the art.

The Fan 15 has a number of flexible metal Blades 19 which flatten as the Shroud 13 spins faster due to high speed ambient winds. This “blade flattening” effect reduces wind noise, vibration, and lengthens bearing life by reducing load.

In the current embodiment, the Fan 15 has four large Blades 19 in the embodiment shown in the figures, but an embodiment could easily have three to six blades. This Fan 15 is fixed in relation to the Shroud 13, so when the Shroud 13 turns, the Fan 15 turns as well.

The purpose of the Fan 15 is to improve extraction of the warm air in the attic by pulling the air out when the Fan 15 turns. The Shroud 13 powers the motion of the Fan 15 because the two elements are attached to the same shaft and may be directly connected.

The Support Structure 21 is connected to a metal Sleeve 29 that extends through the roof which is over an attic area. Warm air is pulled from the attic through the roof and to the area outside and above the roof.

The Invention 11 differs from previous attic fans because it is deliberately designed to be slightly less efficient by placing the integrated Fan in the volume of the Turbine Head 13, rather than below the shroud and in the metal Sleeve 19 where other inventors have placed their fans. The higher efficiency comes at a cost because the sleeve has to be able to fit the fan within it and not have an excessively long Sleeve 19 that extends past the “roof wall”. Keeping the Fan in the Turbine itself makes the invention more likely to be able to retrofit newer turbines, which may not have space for the Invention.

Throughout this specification, the word “comprise”, and its variations should be understood to mean the inclusion of a stated element or step, but the exclusion of any other element or step. The invention is expected to be constructed with many unmentioned components.

While this invention has been described as it is currently built, the invention is not limited to the disclosed embodiments, but can be employed in various equivalent arrangements included within the spirit and scope of the claims. In practice, for example, the fan blades can be of differing shapes, different number, metal thickness and angle to generate the most rotation and air removal from the attick given an amount of wind.

1) A roof-mounted Attic Ventilation Turbine, comprising:
a. a Turbine Head 13 with a volume defined by a Scoop-Type Fin Assembly 25 which rotates about a vertical Shaft 17, the Scoop-Type Fin Assembly 25 mounted in a roof-top and held in place by a Support Structure 21;
b. an Integrated Fan 15 comprised of a set of Fan Blades 19, which are mounted so that they are within the volume defined by the Scoop-Type Fin Assembly 25, they rotate in a plane that is perpendicular to the vertical Shaft 17, and constructed so that the Integrated Fan 15 rotates with the Turbine Head 13 concentrically around the Shaft 17; and with a set of Fan Blades 19 constructed such that an ambient wind turning the Turbine Head 13 causes the Fan Blades 15 to rotate such that they pull air from within the roof into the Turbine Head 13 and out of the attic.

2) A roof-mounted Attic Ventilation Turbine as in claim 1, in which the Fan Blades 19 flatten as the Turbine Head 13 spins faster to reduce the effective pull of air from the attic and lessens noise generation.

3) A roof-mounted Attic Ventilation Turbine as in claim 1, in which the Fan Blades 19 are constructed from 0.012″ to 0.08″ sheet aluminum, with a 35° to 45° angled blade which flattens as the Head 13 and Blades spin faster to reduce the effective pull of air from the attic and lessens noise generation.

4) A roof-mounted Attic Ventilation Turbine as in claim 1, in which the Support Structure 21 is connected to a Fan Blades 19 flatten as the Head 13 spins faster to reduce the effective pull of air from the attic and lessens noise generation.
